(19) United States
(12) Patent Application Publication
(10) Pub. No.: US 2025/0087721 A1
(43) Pub. Date: Mar. 13, 2025

(54) FUEL CELL SYSTEM HAVING TWO-PHASE COOLING WITH AN EJECTOR

(71) Applicant: Aerostack GmbH, Dettingen an der Erms (DE)

(72) Inventors: Markus SCHUDY, Dettingen an der Erms (DE); Marcus-Benedict BUNTZ, Dettingen an der Erms (DE); Christoph ZIEGLER, Dettingen an der Erms (DE)

(21) Appl. No.: 18/883,103

(22) Filed: Sep. 12, 2024

(30) Foreign Application Priority Data
Sep. 13, 2023 (DE) 102023124683.6

(51) Int. Cl. H01M 8/04029; H01M 8/04014

(52) U.S. Cl. CPC H01M 8/04029; H01M 8/04014; H01M 2250/20

(57) ABSTRACT

A fuel cell system having a two-phase cooling system includes at least one fuel cell with a coolant inlet and a coolant outlet, a condenser to condense and to supercool the coolant, a pump to pump the supercooled coolant, and at least one ejector fluidically connected to the coolant outlet, the pump, the condenser and the fuel cell to supply the coolant to the fuel cell.

### TECHNICAL FIELD

The disclosure herein generally relates to the technical field of air travel. The description relates, in particular, to a fuel cell system having two-phase cooling with an ejector and to an aircraft having such a fuel cell system.

### BACKGROUND

Fuel cells are one possible solution for generating power in aircraft drive systems or the emission-free on-board power supply (APU=Auxiliary Power Unit) without undesired emissions. Polymer electrolyte membrane fuel cells (PEMFC) generate energy and power due to the electrochemical reaction of hydrogen and oxygen to form water. This reaction produces heat which has to be discharged. In commercial fuel cell stacks, this is carried out via liquid cooling.

One potential alternative with significant potential for weight reduction in the system is the replacement of the liquid cooling by two-phase cooling. The latent heat of evaporation is used here in order to discharge large quantities of heat from the fuel cells. In addition, compared to the single-phase cooling, the high heat transfer coefficient improves the performance of the thermal management system. The two-phase cooling is based on the phase transitions in the evaporator (fuel cells) and in the heat exchanger relative to the surroundings (condenser). In order to be able to pump the coolant to the fuel cell, it is necessary for the coolant to be supercooled, i.e. to be in the liquid state (avoiding cavitation of the pump). Supercooling refers here to the temperature range below the boiling point of the coolant. The supercooled coolant then passes into the fuel cell where its temperature is increased, and the coolant starts to boil. The presence of this steep temperature gradient in the intake zone can be damaging to the fuel cell. Temperatures which are too low in this region can lead to condensation of water in the gas channels (flooding). In order to overcome this and other risks, a preheater or recuperator is generally inserted upstream of the evaporator (fuel cell). However, this preheater/recuperator can be large and reduce the weight advantages of the two-phase cooling.

### SUMMARY

It can be regarded as an object of the disclosure herein to provide a fuel cell system having reduced weight.

This object is achieved by the subject matter and embodiments disclosed herein.

According to one aspect, a fuel cell system has a two-phase cooling system. The fuel cell system also comprises at least one fuel cell with a coolant inlet and a coolant outlet.

According to one embodiment, a fuel cell system also has an accumulator, wherein a phase separation into the gas and liquid phase takes place in the accumulator, wherein the accumulator is fluidically connected to the fuel cell and is designed to contain coolant flowing out of the fuel cell in a liquid phase in a first portion and in a gas phase in a second portion. Also included is a condenser, wherein the condenser is fluidically connected to the accumulator and is designed to condense and to supercool the coolant.

The fuel cell system also has a pump, wherein the pump is designed to pump the supercooled coolant. The fuel cell system also has an ejector. The ejector inlet (propulsion jet) can be connected via the pump to the condenser. The ejector inlet (suction side) can either be connected to the coolant outlet of the fuel cell or to the first portion of the accumulator. The ejector inlet can also be connected to the second portion of the accumulator.

A fuel cell system within the meaning of the disclosure herein is a technological unit which consists of a plurality of components and serves for converting chemical energy into electrical energy by electrochemical reactions. It generally comprises one or more fuel cells which function as electrochemical cells and represent the main component of the system. In addition, the system contains further components such as a fuel supply mechanism, an oxidizing agent supply mechanism, an electrolyte solution, electrodes, a catalyst and an electrical connection.

The fuel cell system uses a chemical reaction between a fuel and an oxidizing agent, typically hydrogen and oxygen, in order to generate electrochemical power. Water is produced here as a single product, whereby the fuel cell system is regarded as an environmentally friendly energy source. The generated electrical energy can then be used for supplying electrical appliances, vehicles or for generating power in various applications.

A two-phase cooling system within the meaning of the disclosure herein is a cooling solution which aims to discharge large quantities of heat in an efficient manner by using the phase transition from liquid to vapor. It is frequently used in situations in which conventional single-phase cooling systems reach their limits and cannot sufficiently provide heat dissipation.

A coolant which can exist both in liquid and in gaseous form at suitable temperatures and pressures is used in a two-phase cooling system. The coolant absorbs heat from the source to be cooled and evaporates, whereby it is transferred from a liquid state into a gaseous state. The resulting vapor absorbs large quantities of heat here.

The phase change from liquid to vapor permits an effective heat transfer. This leads to an improved cooling performance and a more efficient heat dissipation.

A two-phase cooling system generally consists of an evaporator, in which the coolant absorbs heat and evaporates, and a condenser in which the vapor is condensed again and outputs the heat. The condensate is then conducted back into the evaporator in order to continue the cooling circuit.

A coolant inlet within the meaning of the disclosure herein is an opening or a connection in a fuel cell of a cooling system through which the cooling medium, in this case the cooling liquid, is introduced into the system. The coolant inlet permits the controlled entry of the cooling liquid into the corresponding region or the components which have to be cooled.

A coolant outlet within the meaning of the disclosure herein is an opening or a connection in a cooling system through which the cooling medium, in this case the cooling liquid, is diverted from the system. The coolant outlet permits the controlled exit of the heated cooling liquid from the corresponding region or the components in order to cool them and to ensure the heat exchange.

An accumulator within the meaning of the disclosure herein is a component or a device which serves to carry out a phase separation between the gas and liquid phase, for example due to gravity.

In an accumulator, one or more flows which contain gas and liquid are combined or supplied. Due to gravity, a separating force acts on the phases which have different densities. This leads to the heavier medium (generally the liquid) collecting on the base of the accumulator, while the lighter medium (generally the gas) is located in the upper region of the accumulator.

One possible accumulator is a heat-controlled accumulator (HCA):

such an accumulator comprises a volume which is filled with vapor and liquid of a single working fluid, without a diaphragm being provided. The pressure in an HCA is controlled by a heater.

A further possible accumulator is a pressure-controlled accumulator (PCA): such an accumulator comprises a volume which is mechanically pressurized by a piston or by gaseous pressure (with a bladder or diaphragm).

The accumulator is constructed such that it permits an efficient separation and accumulation of the two phases. This can be achieved by the use of gravity separators, partition walls, funnels or other special structures. The aim is to ensure that the gas and the liquid are separated and accumulate in separate regions in order to permit an effective use or further processing.

A condenser within the meaning of the disclosure herein is a component or a device which serves to condense vapor or gas into a liquid phase. The condenser is fluidically connected to the accumulator which means that the coolant can circulate between the two components.

The main function of the condenser is to condense the coolant, by the coolant outputting heat and thus being transferred from a gaseous state into a liquid state. This process generally takes place by cooling the vapor or gas, by it being brought into contact via the condenser with a medium which has a lower temperature. The result of this cooling is that the molecules of the vapor or gas contract and condense, whereby they accumulate in liquid form.

Moreover, the condenser is designed such that it can supercool the coolant. Supercooling means that the temperature of the condensed coolant is below its saturation point, i.e. below the temperature at which it would normally condense. This permits the coolant to absorb more heat before it evaporates or is transported again. The supercooling is important in order to avoid cavitation on the pump.

A pump within the meaning of the disclosure herein is an appliance or a device which serves to pump or to move liquids or gases from one location to another. In the present case, the pump is specifically designed to pump the supercooled coolant.

The main function of a pump is to apply mechanical energy to the coolant in order to move it along a line or through a system. The pump generates a pressure gradient or flow gradient which pumps the coolant from a lower pressure region to a higher pressure region. This is implemented by the transfer of kinetic energy or by changing the volume of the pump, in order to suction the coolant and then to force it in the desired direction.

In the specific case of the supercooled coolant, the pump is configured such that it receives the liquid phase of the coolant and transports it along the system. The pump has to be able to deal with the low pressure of the supercooled coolant and create sufficient pressure in order to pump it through the system. This permits a continuous circulation of the supercooled coolant in order to maintain the desired cooling action.

There are various types of pumps which are suitable for different applications and fluids, such as for example centrifugal pumps, piston pumps or screw pumps. The choice of the correct pump depends on the specific requirements of the system, including the flow volume, the pressure range and the type of coolant.

An ejector within the meaning of the disclosure herein is an appliance which is used in order to mix and to convey liquids or gases by using the pressure difference between the two fluids. In the present case, the ejector is fluidically connected to different components of the system, including the first portion of the accumulator, the second portion of the accumulator, the pump, the condenser and the fuel cell.

The main function of the ejector is to mix the coolant in the gas phase from the first portion of the accumulator with the supercooled coolant from the condenser and then to supply it to the fuel cell. The ejector uses the pressure difference between the two fluids in order to suction the coolant in the gas phase and to mix it with the supercooled coolant.

The ejector operates according to the principle of the propulsion jet effect. The supercooled coolant is forced by the pump into the ejector and accelerated there in a nozzle. This produces a low pressure region in the ejector which suctions the coolant in the gas phase from the first portion of the accumulator. The two flows are then mixed with one another in the ejector and form a homogenous mixture of gas and supercooled coolant.

This mixture is then conveyed to the fuel cell in order to ensure the cooling there. By mixing the coolant in the gas phase with the supercooled coolant, preheating of the coolant is achieved and the supercooling of the coolant at the coolant inlet of the fuel cell is compensated.

The ejector plays a significant role when mixing and supplying the coolant in the gas phase with the supercooled coolant in the system. It permits an efficient use of the prevailing pressure difference and ensures a uniform distribution of the coolant for cooling the fuel cell.

A further advantage is in the supply of gas bubbles in the inflow to the coolant inlet of the fuel cell, the gas bubbles being advantageous in order to counteract boiling retardation of the coolant. They help to reduce the surface tension which leads to a more effective heat exchange at higher temperatures.

According to one embodiment, the ejector comprises a Venturi tube.

A Venturi tube is a special tube portion with a constricted cross-sectional surface in the center. The Venturi tube consists of a broader inlet, a constricted neck and a broader outlet.

The mode of operation of an ejector in the form of a Venturi tube is based on the Bernoulli principle and the pressure difference which is produced by the change in velocity of the fluid in a Venturi tube. If a fluid, for example a gas or a liquid, flows through the inlet of the ejector, it passes the constricted neck of the Venturi tube. In this narrow region, the velocity of the fluid increases while the pressure reduces.

The pressure difference between the inlet and the neck of the ejector generates a suction effect. As a result, a second fluid, which is in a different line or another container, is drawn into the ejector. The second fluid is then mixed with the first fluid in the outlet of the ejector and can be transported or used together.

According to one embodiment, the fuel cell is a fuel cell stack with at least one base plate and the base plate comprises the ejector.

A weight reduction is achieved by combining these two components, since separate ejectors and additional connecting lines can be dispensed with. Normally, a conventional system requires separate ejectors which are externally connected to the fuel cell stack. These additional components increase the overall weight and the space requirement of the system.

The weight is reduced by the integration of the ejector in the base plate of the fuel cell stack, since no additional external components are required. The base plate serves both as a structural element of the fuel cell stack and as an ejector. As a result, weight and space are saved, which in particular is advantageous in applications with limited installation space, such as for example in air travel and space travel or in mobile applications.

The weight saving due to the integration of the ejector in the base plate of the fuel cell stack contributes to the efficiency of the system by reducing the overall weight and at the same time permitting a compact design. This advantage can lead to improved performance, greater energy efficiency and an increased range of the fuel cell system.

According to one embodiment, the coolant comprises methanol and/or ethanol.

Methanol and ethanol provide different advantages as coolant. They have a lower boiling point, whereby they can evaporate at higher temperatures and thus permit improved cooling. The essential advantage of alcohols is their low freezing point and their high evaporation enthalpy.

A further advantage is in the low viscosity of methanol in comparison with water. As a result, the throughflow is facilitated and the energy consumption of the pump reduced.

Moreover, methanol and ethanol have a high evaporation enthalpy. As a result, very small mass flows can be implemented in the system, whereby pressure loss is reduced. As a result, lines and pumps can be of smaller dimensions than with the liquid cooling, which results in a weight saving in the system.

According to one embodiment, the at least one fuel cell is a fuel cell stack with a media module, wherein the media module comprises the ejector.

According to one embodiment, the fuel cell system also comprises a bypass line with a pitot insert.

The advantage of a pitot insert can be seen here to be that the gas phase can be drawn off with an annular flow in a targeted manner. The gas phase has a higher enthalpy than the liquid phase in the vicinity of the wall, and the supercooling at the inlet of the fuel cell can be reduced more effectively thereby.

According to one aspect, an aircraft comprises a fuel cell system of the aforementioned construction.

According to one embodiment, the fuel cell system also comprises a bypass line having a pump, wherein the coolant inlet is fluidically connected to the coolant outlet via the bypass line. The bypass line makes it possible to achieve targeted bypass of the normal coolant circuit and to conduct the warm cooling medium directly to the cold cooling medium.

Thus, a rapid and efficient heat transfer can be made possible in order to increase the temperature of the cooling medium in an effective manner. The bypass line can be used in various applications in order to permit targeted cooling or specific temperature control and to make a preheater/recuperator dispensable.

According to one embodiment, the fuel cell system also has a thermally conductive element between the coolant inlet and coolant outlet, wherein the thermally conductive element is designed to transfer heat from the coolant outlet to the coolant inlet.

The main advantage of a thermally conductive element between the coolant inlet and the coolant outlet is in the efficient heat transfer. By the use of a thermally conductive element, the heat which has accumulated in the coolant outlet can be transferred effectively to the coolant inlet. As a result, the heat discharge is improved and the temperature in the coolant circuit stabilized by the cooling liquid being preheated.

### BRIEF DESCRIPTION OF THE DRAWINGS

Example embodiments of the disclosure herein are described in more detail hereinafter with reference to the accompanying drawings. The views are schematic and not to scale. The same reference signs refer to the same or similar elements. In the drawings:

FIG. 1 shows a fuel cell system;

FIG. 2 shows a further fuel cell system;

FIG. 3 shows a further fuel cell system;

FIG. 4 shows a pitot insert;

FIG. 5 shows a further fuel cell system with a pitot insert; and

FIG. 6 shows an aircraft.

### DETAILED DESCRIPTION

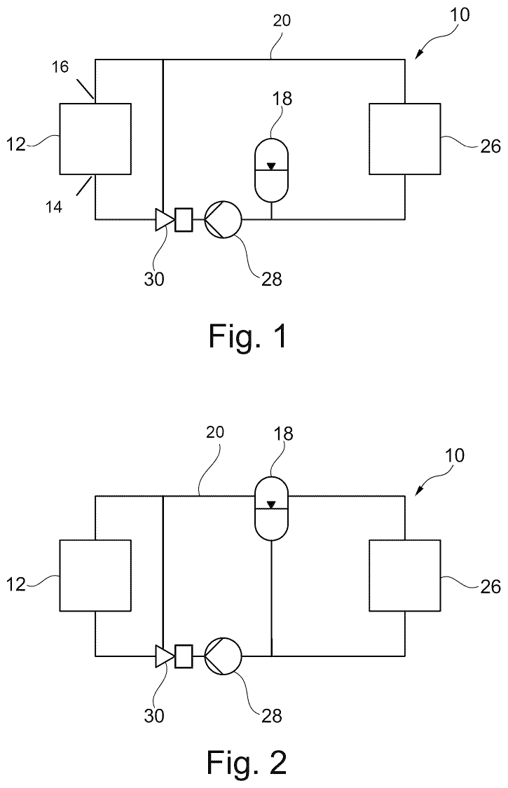

FIG. 1 shows a fuel cell system 10 which is equipped with an efficient two-phase cooling system. The fuel cell system 10 comprises at least one fuel cell 12 which has a coolant inlet 14 and a coolant outlet 16.

The central component of the cooling system is the accumulator 18 which serves as compensation for the expansion of the coolant and for pressurizing the cooling system.

In order to treat the coolant further, a condenser 26 is integrated in the system 10. The condenser 26 is fluidically connected to the accumulator 18 and is designed to condense and to supercool the coolant 20. As a result, the heat is efficiently discharged from the coolant.

In order to ensure the flow of supercooled coolant 20, a pump 28 is used. The pump 28 is designed to pump the supercooled coolant 20 and to maintain the circuit.

A further important element of the two-phase cooling system is the ejector 30. The ejector 30 is fluidically connected to the inlet 14 and the outlet 16 of the fuel cell 12. The purpose of the ejector is to mix the coolant in the gas phase from the outlet 16 with the supercooled coolant from the condenser 26 and then to supply this to the fuel cell 12 via the inlet 14.

By the cooperation of these components, the two-phase cooling system enables efficient cooling of the fuel cell 12. It ensures optimal temperature control by the supercooling at the inlet 14 being reduced and thus contributes to the performance and durability of the fuel cell system.

FIG. 2 shows a further embodiment of a fuel cell system 10 which is equipped with an efficient two-phase cooling system. The fuel cell system 10 also comprises at least one fuel cell 12 which has a coolant inlet 14 and a coolant outlet 16.

The essential difference from the embodiment of FIG. 1 is that the accumulator is connected to the return line and, as a result, the gas phase can be mixed with the liquid phase. The accumulator is also connected to the return line and, as a result, the gas phase and liquid phase can be separated from one another.

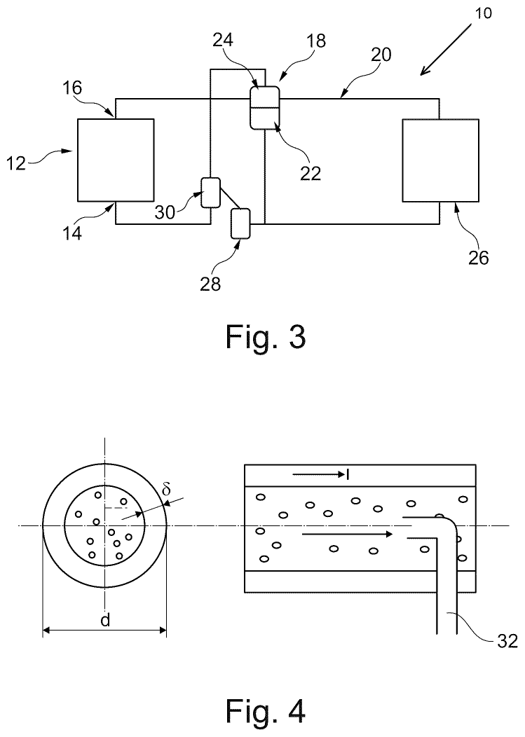

FIG. 3 shows a fuel cell system 10 which is equipped with an efficient two-phase cooling system. The fuel cell system 10 comprises at least one fuel cell 12 which has a coolant inlet 14 and a coolant outlet 16.

A central component of the cooling system is the accumulator 18 which permits a phase separation between the gas and liquid phase due to gravity.

The accumulator 18 is fluidically connected directly to the fuel cell 12 and ensures that the coolant 20 from the fuel cell is divided into two portions. Here, the coolant 20 is in the liquid phase in the first portion 22 of the accumulator 18 and in the gaseous phase in the second portion 24.

In order to treat the coolant further, a condenser 26 is integrated in the system 10. The condenser 26 is fluidically connected to the accumulator 18 and is designed to condense and to supercool the coolant 20. The heat is efficiently discharged thereby from the coolant.

A pump 28 is used in order to ensure the flow of the supercooled coolant 20. The pump 28 is designed to pump the supercooled coolant 20 and to maintain the circuit.

A further important element of the two-phase cooling system is the ejector 30. The ejector 30 is fluidically connected to the first portion 22 of the accumulator 18, the second portion 24 of the accumulator 18, the pump 28, the condenser 26 and the fuel cell 12. The purpose of the ejector is to mix the coolant 20 in the gas phase from the accumulator 18 with the supercooled coolant from the condenser 26 and then to supply this to the fuel cell 12.

By the cooperation of these components, the two-phase cooling system enables efficient cooling of the fuel cell 12. It ensures optimal temperature control and thus contributes to the performance and durability of the fuel cell system 10.

The essential difference from the embodiment of FIG. 1 and FIG. 2 is a phase separation in the accumulator and the targeted injection of the vapor phase via the ejector to the inlet of the fuel cell.

FIG. 4 shows a pitot insert 32 inside a coolant line. As a result, with an annular flow the gas phase can be drawn off in a targeted manner. The gas phase has a higher enthalpy than the liquid phase in the vicinity of the wall and the supercooling at the inlet of the fuel call can be reduced more effectively thereby.

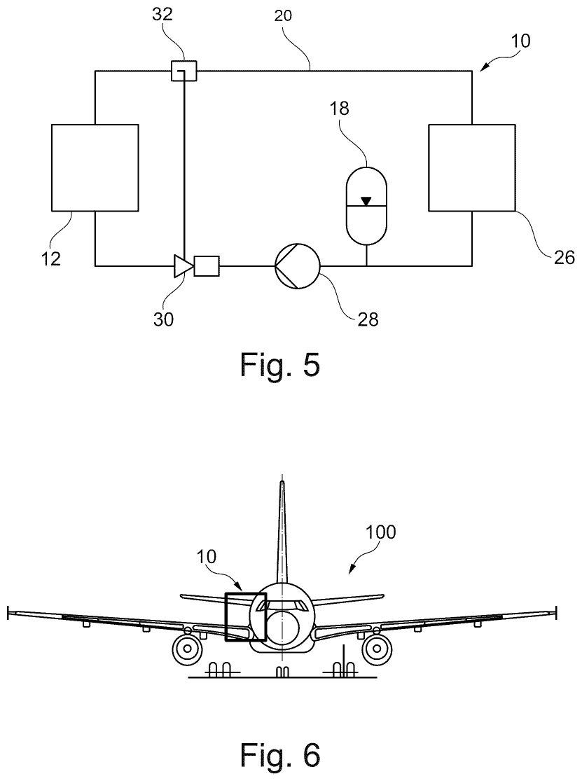

FIG. 5 shows a further embodiment of a fuel cell system 10 with a pitot insert 32 inside a coolant line.

FIG. 6 shows an aircraft 100 with a described fuel cell system 10. This enables a preheater/recuperator to be dispensed with, which leads to advantageous weight savings.

In addition, it should be mentioned that “comprising” or “having” does not exclude any other elements or steps and “a” or “one” does not exclude a plurality. Moreover, it should be mentioned that features or steps which have been described with reference to one of the above example embodiments can also be used in combination with other features or steps of other example embodiments described above. Reference signs in the claims are not to be regarded as a limitation.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 Fuel cell system
12 Fuel cell
14 Coolant inlet
16 Coolant outlet
18 Accumulator
20 Coolant
22 First portion
24 Second portion
26 Condenser
28 Pump
30 Ejector
32 Pitot insert
100 Aircraft

1. A fuel cell system having a two-phase cooling system, comprising:
at least one fuel cell with a coolant inlet and a coolant outlet;
a condenser to condense and supercool coolant;
a pump to pump the supercooled coolant; and
at least one ejector fluidically connected to the coolant outlet, the pump, the condenser and the fuel cell and configured to supply the coolant to the fuel cell.

2. The fuel cell system of claim 1, further comprising an accumulator for a phase separation into a gas and liquid phase to take place in the accumulator, wherein the accumulator is fluidically connected to the fuel cell and is configured to contain coolant flowing out of the fuel cell in a liquid phase in a first portion and in a gas phase in a second portion, wherein the ejector is configured to mix the coolant in the gas phase from the accumulator with the supercooled coolant from the condenser and to supply it to the fuel cell.

3. The fuel cell system of claim 1, wherein the ejector comprises a Venturi tube.

4. The fuel cell system of claim 1, wherein the at least one fuel cell is a fuel cell stack with at least one base plate and the base plate comprises the ejector.

5. The fuel cell system of claim 1, wherein the coolant comprises methanol and/or ethanol.

6. The fuel cell system of claim 1, wherein the at least one fuel cell is a fuel cell stack with a media module, wherein the media module comprises the ejector.

7. The fuel cell system of claim 1, wherein the fuel cell system also comprises a bypass line with a pitot insert.

8. An aircraft having the fuel cell system of claim 1.
